(19) United States
(12) Patent Application Publication
(10) Pub. No.: US 2015/0159569 A1
(43) Pub. Date: Jun. 11, 2015

(54) METHOD AND APPARATUS FOR DETECTING COMBUSTION PHASE OF ENGINE BY ANGULAR ACCELERATION SIGNAL AND COMBUSTION DATA OF SINGLE CYLINDER

(71) Applicants: Hyundai Motor Company, Seoul (KR); Kia Motors Corporation, Seoul (KR)

(72) Inventors: Seungeun Yu, Seoul (KR); Kyoungchan HAN, Gunpo-si (KR)

(73) Assignees: Hyundai Motor Company, Seoul (KR); Kia Motors Corporation, Seoul (KR)

(21) Appl. No.: 14/294,969

(22) Filed: Jun. 3, 2014

(30) Foreign Application Priority Data
Dec. 5, 2013 (KR) 10-2013-0150694

(51) Int. Cl. F02D 41/00; G01M 15/08

(52) U.S. Cl. CPC F02D 41/009; G01M 15/08

(57) ABSTRACT

Disclosed are a method and an apparatus of detecting a combustion phase of an engine by an angular acceleration signal and combustion data of a single cylinder. The method may include calculating a point of maximum angular acceleration of each engine cylinder during an explosion stroke, detecting a combustion phase of an engine cylinder provided with a combustion pressure sensor, calculating a time difference between the point of maximum angular acceleration and the combustion phase of the engine cylinder provided with the combustion pressure sensor, and determining a combustion phase of an engine cylinder where the combustion pressure sensor is not mounted by using the time difference and the point of maximum angular acceleration of the engine cylinder where the combustion pressure sensor is not mounted.

### CROSS-REFERENCE TO RELATED APPLICATION

The present application claims priority of Korean Patent Application Number 10-2013-0150694 filed on Dec. 5, 2013, the entire contents of which application are incorporated herein for all purposes by this reference.

### BACKGROUND OF INVENTION

1. Field of Invention

The present invention relates to a method and an apparatus for detecting a combustion phase of an engine by an angular acceleration signal and combustion data of a single cylinder. More particularly, the present invention relates to a method and an apparatus for detecting a combustion phase of an engine cylinder where a combustion pressure sensor is not mounted by using a signal of combustion pressure of an engine cylinder provided with the combustion pressure sensor mounted thereon and an angular acceleration signal.

2. Description of Related Art

An internal combustion engine that converts thermal energy generated by fuel combustion to mechanical energy may be classified as a gas internal combustion engine, a gasoline internal combustion engine, and a diesel internal combustion engine depending on a fuel type. The internal combustion engine is used for a vehicle, heavy equipment, a ship, a generator, and so on.

A compression ignition type of internal combustion engines generates shaft power by using high temperature and high pressure generated by combustion. Particularly, the compression ignition type of internal combustion engines which has multiple cylinders requires precise control in order to generate the same pressure of each engine cylinder.

Meanwhile, knocking such as by abnormal combustion may occur due to spontaneous ignition of a fuel-air mixture in the compression ignition type of internal combustion engines. Components in a combustion chamber may be damaged by thermal load and pressure waves because of the repeated knocking.

A point of time to ignition is an important parameter that influences the tendency of knocking of the internal combustion engine. The knocking occurs when the fuel-air mixture is ignited too early in the combustion chamber. Therefore, if the knocking is detected in the internal combustion engine, a method of delaying a point of time to ignition after the knocking has been developed. However, the delayed ignition may cause a substantial loss of efficiency, so an apparatus to control knocking is used for detecting whether the knocking occurs in the internal combustion engine.

Knocking control should be performed safely and precisely so as to prevent damage to the internal combustion engine and improve efficiency of combustion. On this account, needs of a combustion phase control have been increased in order to guarantee combustion stability and reduce an exhaust gas.

Generally, a method of controlling the combustion phase that calculates a total amount of mass burned based on pressure and heat production in the combustion chamber and detects the combustion phase by using a point of 50% mass fraction burned (MFB50) has been used.

In order to perform the method as stated above, a combustion pressure sensor is mounted on an engine cylinder for detecting the pressure in the combustion chamber. However, if the combustion pressure sensor is mounted on only one engine cylinder, data of engine cylinders where the combustion pressure sensor is not mounted may not be detected. On the other hand, if the combustion pressure sensor is mounted on all engine cylinders, cost may be increased.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a method and an apparatus for detecting a combustion phase of an engine having advantages of detecting a combustion phase of all engine cylinders by obtaining information of an engine cylinder where a combustion pressure sensor is not mounted on the basis of a signal of combustion pressure of an engine cylinder provided with a combustion pressure sensor mounted thereon and a signal of angular acceleration.

Various aspects of the present invention provide a method of detecting a combustion phase of an engine by an angular acceleration signal and combustion data of a single cylinder that may include: calculating a point of maximum angular acceleration of each engine cylinder during an explosion stroke; detecting a combustion phase of an engine cylinder provided with a combustion pressure sensor mounted thereon; calculating a time difference between the point of maximum angular acceleration and the combustion phase of the engine cylinder provided with the combustion pressure sensor mounted thereon; and determining a combustion phase of an engine cylinder where the combustion pressure sensor is not mounted by using the time difference and the point of maximum angular acceleration of the engine cylinder where the combustion pressure sensor is not mounted.

The point of maximum angular acceleration of each engine cylinder during the explosion stroke may be calculated based on an interval between tooth waveforms of a crankshaft position sensor (CPS) signal, and the point of maximum angular acceleration of each engine cylinder during the explosion stroke may correspond to a point of maximum combustion pressure. The interval between tooth waveforms of the crankshaft position sensor (CPS) signal may be corrected by reflecting an interval between tooth waveforms in an overrun region to exclude a mechanical tolerance.

The point of maximum angular acceleration of each engine cylinder during the explosion stroke may be calculated by calculating a factor of time variation rate using the corrected interval between tooth waveforms of the crankshaft position sensor (CPS) signal and by using a minimum point of the factor of time variation rate.

A quadratic function may be generated based on three values including the minimum point of the factor of time variation rate, a factor of time variation rate at a point prior to the minimum point by a predetermined time, and a factor of time variation rate at a point after the minimum point by the predetermined time, and a minimum value of the quadratic function may be designated as a new minimum point of the factor of time variation rate in the calculation of the point of maximum angular acceleration of each engine cylinder during the explosion stroke.

Various other aspects of the present invention provide an apparatus for detecting a combustion phase of an engine by an angular acceleration signal and combustion data of a single cylinder that may include: a detector including a crankshaft position sensor (CPS) mounted on a crankshaft and a combustion pressure sensor mounted on any one of engine cylinders to detect a combustion phase of the engine cylinder; an engine control unit (ECU) configured to determine combustion phases of all engine cylinders based on signals received from the detector; and an injector configured to adjust an amount and a time of fuel injection on the basis of a signal transmitted from the ECU.

The ECU may calculate a time difference between a point of maximum angular acceleration and the combustion phase of the engine cylinder provided with the combustion pressure sensor mounted thereon, and determine a combustion phase of an engine cylinder where the combustion pressure sensor is not mounted by using the time difference and the point of maximum angular acceleration of the engine cylinder where the combustion pressure sensor is not mounted.

The detector may detect the combustion phase of the engine cylinder provided with the combustion pressure sensor mounted thereon.

The ECU may calculate a point of maximum angular acceleration of each engine cylinder during an explosion stroke based on an interval between tooth waveforms of the crankshaft position sensor (CPS) signal detected by the detector, wherein the point of maximum angular acceleration of each engine cylinder during the explosion stroke corresponds to a point of maximum combustion pressure. The ECU may correct the interval between tooth waveforms of a crankshaft position sensor (CPS) signal by reflecting an interval between tooth waveforms in an overrun region to exclude a mechanical tolerance.

The ECU may calculate a factor of time variation rate based on the corrected interval between tooth waveforms of the crankshaft position sensor (CPS) signal and calculate the point of maximum angular acceleration of the engine cylinder by using a minimum point of the factor of time variation rate.

The ECU may generate a quadratic function based on three values including the minimum point of the factor of time variation rate, a factor of time variation rate at a point prior to the minimum point by a predetermined time, and a factor of time variation rate at a point after the minimum point by the predetermined time, designate a minimum value of the quadratic function as a new minimum point of the factor of time variation rate, and calculate the point of maximum angular acceleration of the engine cylinder by using the new minimum point of the factor of time variation rate.

According to the present invention, the method and apparatus may precisely diagnose a combustion condition by detecting a combustion phase of all engine cylinders on the basis of combustion data of a single engine cylinder provided with the combustion pressure sensor mounted thereon. Thus, combustion stability can be guaranteed and exhaust gas can be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of an exemplary apparatus of detecting a combustion phase of an engine by an angular acceleration signal and combustion data of a single cylinder according to the present invention.

FIG. 2 is a flowchart showing an exemplary method of determining a combustion phase of an engine by an angular acceleration signal and combustion data of a single cylinder according to the present invention.

FIG. 3 is a graph showing an exemplary process of detecting a minimum point of a factor of time variation rate in order to calculate a point of maximum angular acceleration of an engine cylinder according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Throughout this specification and the claims, unless explicitly described to the contrary, the word “comprise” and variations such as “comprises” or “comprising” will be understood to imply the inclusion of stated elements but not the exclusion of any other elements. Like reference numerals designate like elements throughout the specification.

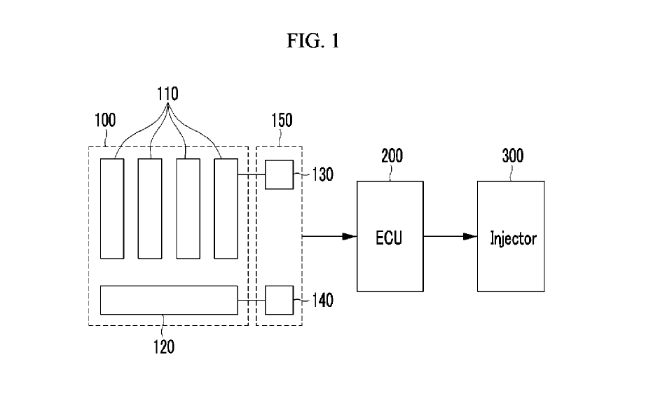

FIG. 1 is a block diagram of an apparatus of detecting combustion phase of an engine by an angular acceleration signal and combustion data of a single cylinder according to various embodiments of the present invention. As shown in FIG. 1, an apparatus for detecting a combustion phase of an engine by an angular acceleration signal and combustion data of a single cylinder according to various embodiments of the present invention detects the combustion phase of each engine cylinder 110 in the engine 100 including at least one engine cylinder. An intake valve is mounted in the at least one engine cylinder 110 so as to inhale a fuel-air mixture into the combustion chamber of the engine cylinder 110, and the fuel-air mixture generates energy by being burnt in the combustion chamber. In addition, an exhaust valve is mounted on the at least one engine cylinder 110 so as to expel exhaust gas.

Each engine cylinder 110 has a piston and connecting rod connected to the piston, so the energy generated by combustion of the fuel-air mixture is transmitted to a crankshaft 120. The crankshaft 120 which is mounted in a crankcase transmits torque of the engine 100 to the outside by converting power of the piston during an explosion stroke of each engine cylinder to engine torque.

The apparatus for detecting a combustion phase of the engine 100 as stated above includes a detector 150, an engine control unit (ECU) 200, and an injector 300.

The detector 150 detects the combustion phase of a particular engine cylinder by measuring combustion pressure and a point of maximum combustion pressure of the engine cylinder 110. The detector 150 may include a combustion pressure sensor 130 and a crankshaft position sensor (CPS) 140. The combustion pressure sensor 130 may detect the combustion pressure by a piezoelectric element according to a combustion state of the combustion chamber and output a corresponding electrical signal, but it is not limited thereto.

The detector 150 may detect the combustion phase such as the combustion phase of 50% mass fraction burned (MFB50) by continuously detecting the combustion pressure of the engine cylinder provided with the combustion pressure sensor 130 mounted thereon. MFB50 means a point of 50% generation amount of total thermal energy generated by a fuel-air mixture that is burned. Detection of the combustion phase of MFB50 by the detector 150 may be the same as or similar to those in the conventional art.

The crankshaft position sensor (CPS) 140 detects a crank angle from a rotation angle or a rotation position of the crankshaft of the engine 100, and transmits a corresponding signal of the CPS to the ECU 200. The crankshaft position sensor (CPS) 140 may detect the crank angle from the rotation angle of the crankshaft directly or calculate the crank angle from the rotation position of a distributor, but it is not limited thereto.

In addition, the crankshaft position sensor (CPS) 140 may detect a point of maximum combustion pressure of each engine cylinder 110. The point of maximum combustion pressure of each engine cylinder 110 may be the same as a point of maximum angular acceleration at which power to accelerate the piston downward has a maximum value. Therefore, the crankshaft position sensor (CPS) 140 detects the point of maximum combustion pressure from the point of maximum angular acceleration of the engine by using the CPS signal.

The detector 150 may detect an interval between tooth waveforms of the CPS signal output by the CPS 140 in order to calculate the point of maximum angular acceleration. A flywheel mounted on the crankshaft is rotated by torque of the crankshaft generated by the explosion stroke of the engine 100. Therefore, the CPS signal output by the CPS 140 has tooth waveforms according to a gear of the flywheel, so that the detector 150 may calculate the point of maximum angular acceleration of the engine by detecting an interval between tooth waveforms of the CPS signal.

The interval between tooth waveforms of the CPS signal detected by the detector 150 may be corrected by reflecting an interval between tooth waveforms in an overrun region in order to exclude a mechanical tolerance.

In addition, the detector 150 or the ECU 200 calculates a factor of time variation rate by using the corrected interval between tooth waveforms of the CPS signal in order to calculate the point of maximum angular acceleration of the engine. After that, the detector 150 or the ECU 200 calculates a minimum point of the factor of time variation rate.

The interval between tooth waveforms of the CPS signal decreases when the factor of time variation rate has a minimum value, so the point of maximum angular acceleration of the engine may be the same as a minimum value of the factor of time variation rate. Thus, the factor of time variation rate may be determined by the following equation:

$$α ( n ) = \frac{{t}_{n} - {t}_{n - 1}}{{( {t}_{n - 1} )}^{3}}$$

$$α\_d ( n ) = α ( n ) - α ( n - 1 )$$

Herein, α is the factor of time variation rate between tooth waveforms of the CPS signal and t is the interval between tooth waveforms of the CPS signal.

The engine control unit (ECU) 200 receives the combustion phase of the engine cylinder provided with the combustion pressure sensor mounted thereon from the detector 150 and the point of maximum angular acceleration of each engine cylinder which is same as the point of maximum combustion pressure of each engine cylinder during the explosion stroke.

The ECU 200 calculates a time difference between the point of maximum angular acceleration and the combustion phase of the engine cylinder provided with the combustion pressure sensor mounted thereon. The time difference between the point of maximum angular acceleration and the combustion phase of the engine cylinder provided with the combustion pressure sensor mounted thereon may be calculated from a difference of a crankshaft angle.

After that, the ECU 200 determines a combustion phase of the engine cylinder where the combustion pressure sensor is not mounted by using the time difference and the point of maximum angular acceleration of the engine cylinder where the combustion pressure sensor is not mounted.

In addition, the ECU 200 controls an amount of fuel injection and a time of fuel injection of the injector 300 by using the combustion phase of the engine cylinder provided with the combustion pressure sensor mounted thereon and the combustion phase of the engine cylinder where the combustion pressure sensor is not mounted. To this end, the ECU 200 may be implemented to include at least one processor that is operated by a predetermined program, and the predetermined program may be programmed in order to perform each step of a method of detecting a combustion phase of an engine by an angular acceleration signal and a combustion data of a single cylinder according to various embodiments of the present invention.

The injector 300 which is a fuel injection nozzle equipped with a solenoid valve injects fuel by opening the solenoid valve when a current flows through the solenoid valve according to a fuel injection signal output from the ECU 200. Therefore, the injector 300 adjusts an amount of fuel injection and a time of fuel injection according to the fuel injection signal on the basis of combustion data of all engine cylinders determined by the ECU 200. For this reason, combustion stability can be guaranteed because the combustion state can be diagnosed precisely.

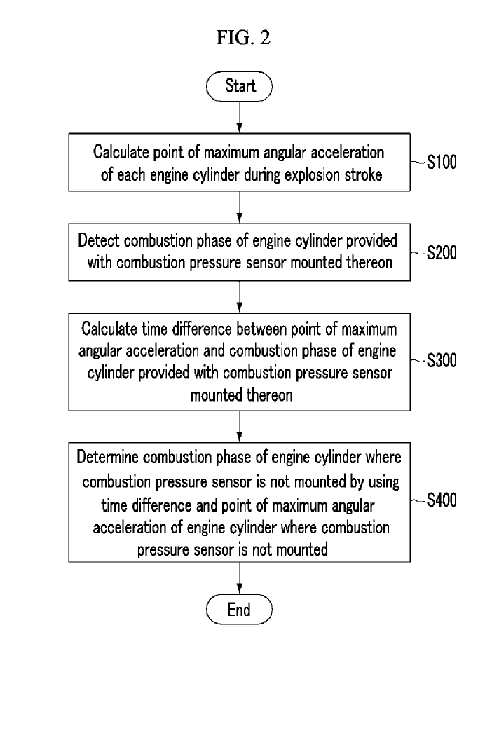

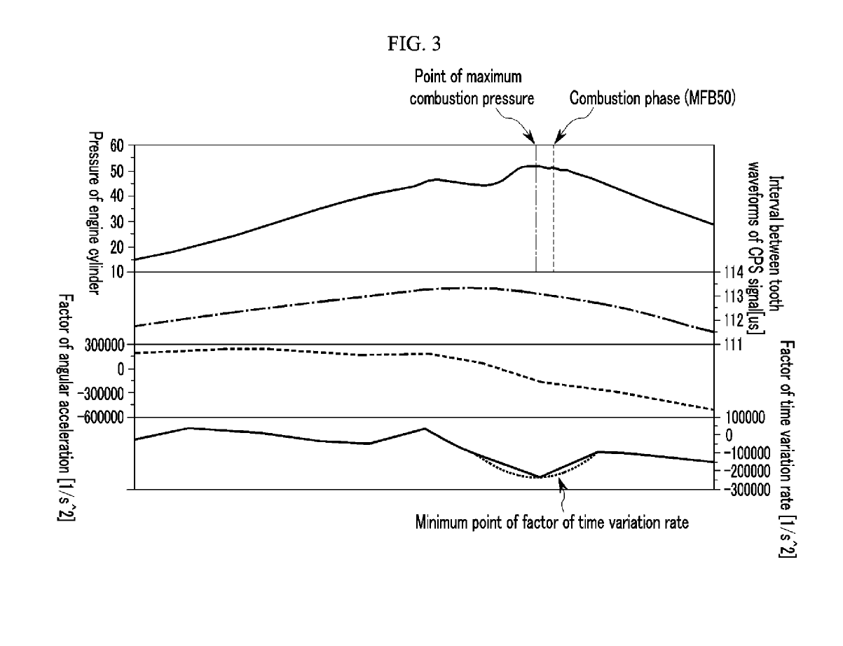

Hereinafter, referring to FIG. 2 and FIG. 3, a method of detecting a combustion phase of an engine by an angular acceleration signal and combustion data of a single cylinder according to various embodiments of the present invention will be described in detail.

FIG. 2 is a flowchart showing a method of detecting a combustion phase of an engine by an angular acceleration signal and combustion data of a single cylinder according to various embodiments of the present invention. As shown in FIG. 2, the method of detecting a combustion phase of an engine by an angular acceleration signal and combustion data of a single cylinder includes calculating a point of maximum angular acceleration of each engine cylinder during an explosion stroke at step S100, detecting a combustion phase of the engine cylinder provided with a combustion pressure sensor mounted thereon at step S200, calculating a time difference between the point of maximum angular acceleration and the combustion phase of the engine cylinder provided with the combustion pressure sensor mounted thereon at step S300, and determining a combustion phase of the engine cylinder where the combustion pressure sensor is not mounted by using the time difference and the point of maximum angular acceleration of the engine cylinder where the combustion pressure sensor is not mounted at step S400.

The method of detecting a combustion phase of an engine by an angular acceleration signal and combustion data of a single cylinder starts with the detector 150 calculating the point of maximum angular acceleration of each engine cylinder during an explosion stroke at step S100.

As stated above, the point of maximum angular acceleration of each engine cylinder 110 during an explosion stroke may be the same as the point of maximum combustion pressure of each engine cylinder 110 at which power to accelerate the piston downward has a maximum value. The point of maximum angular acceleration of the engine that is the same as the point of maximum combustion pressure is calculated by detecting an interval between tooth waveforms of the CPS signal.

The detector 150 may correct the interval between tooth waveforms of the CPS signal by reflecting an interval between tooth waveforms in an overrun region and calculating a factor of time variation rate by using the corrected interval between tooth waveforms of the CPS signal.

In addition, the detector 150 may primarily detect the minimum point of the factor of time variation rate, find a quadratic function by using three values of the minimum point of the factor of time variation rate, a factor of time variation rate at a point prior to the minimum point by a predetermined time, and a factor of time variation rate at a point after the minimum point by the predetermined time, and designate a minimum value of the quadratic function as a new minimum point of the factor of time variation rate.

FIG. 3 is a graph showing a process of detecting a minimum point of a factor of time variation rate in order to calculate a point of maximum angular acceleration of an engine cylinder according to various embodiments of the present invention.

A first graph in FIG. 3 shows a combustion pressure in any one engine cylinder 110. The point of maximum combustion pressure of the engine cylinder 110 is a point at which the combustion pressure has a maximum value. Moreover, as shown in the first graph in FIG. 3, the combustion phase may be detected in the engine cylinder provided with the combustion pressure sensor mounted thereon, and a time difference between the point of maximum combustion pressure and combustion phase may be calculated.

A second graph in FIG. 3 shows the interval between tooth waveforms of the CPS signal. The interval between tooth waveforms of the CPS signal may be a value measured by an angle of 6 degrees depending on a gear of the flywheel mounted on the crankshaft.

A third graph in FIG. 3 shows a factor of angular acceleration in order to calculate the point of maximum angular acceleration of each engine cylinder during an explosion stroke at the step S100, and a fourth graph in FIG. 3 shows the factor of time variation rate calculated by the factor of angular acceleration in the third graph.

As shown in the fourth graph of FIG. 3, the detector 150 primarily detects the minimum point of the factor of time variation rate so as to detect a real minimum point of the factor of time variation rate of the engine cylinder 110 more precisely. After that, the detector 150 may find a quadratic function as shown by a dotted line in the fourth graph of FIG. 3 by using three values of the minimum point of the factor of time variation rate, a factor of time variation rate at a point prior to the minimum point by a predetermined time, and a factor of time variation rate at a point after the minimum point by the predetermined time. Moreover, the detector 150 may designate a minimum value of the quadratic function as the real minimum point of the factor of time variation rate.

As stated above, the detector 150 may calculate the point of maximum angular acceleration of each engine cylinder during an explosion stroke by using the minimum point of the factor of time variation rate which is the minimum value of the quadratic function.

After that, the detector 150 detects the combustion phase of the engine cylinder provided with the combustion pressure sensor mounted thereon at step S200.

After detecting the combustion phase at the step S200, the detector 150 calculates the time difference between the point of maximum angular acceleration and the combustion phase of the engine cylinder provided with the combustion pressure sensor mounted thereon at step S300.

As stated above, the time difference between the point of maximum angular acceleration and the combustion phase of the engine cylinder provided with the combustion pressure sensor mounted thereon may be calculated from a difference of a crankshaft angle.

If the time difference between the point of maximum angular acceleration and the combustion phase of the engine cylinder provided with the combustion pressure sensor mounted thereon is calculated at the step S300, the ECU 200 determines a combustion phase of the engine cylinder where the combustion pressure sensor is not mounted by using the time difference and the point of maximum angular acceleration of the engine cylinder where the combustion pressure sensor is not mounted at step S400.

As described above, since the combustion phase of all engine cylinders can be detected by combustion data of a single engine cylinder provided with the combustion pressure sensor mounted thereon, the ECU 200 may precisely diagnose the combustion condition of each engine cylinder according to various embodiments of the present invention. In addition, the ECU 200 may properly control the amount of fuel injection and the time of fuel injection of the injector 300, so the exhaust gas can be reduced and fuel efficiency can be improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of detecting a combustion phase of an engine by an angular acceleration signal and combustion data of a single cylinder, the method comprising:
calculating a point of maximum angular acceleration of each engine cylinder during an explosion stroke;
detecting a combustion phase of an engine cylinder provided with a combustion pressure sensor mounted thereon;
calculating a time difference between the point of maximum angular acceleration and the combustion phase of the engine cylinder provided with the combustion pressure sensor mounted thereon; and
determining a combustion phase of an engine cylinder where the combustion pressure sensor is not mounted by using the time difference and the point of maximum angular acceleration of the engine cylinder where the combustion pressure sensor is not mounted.

2. The method of claim 1, wherein the point of maximum angular acceleration of each engine cylinder during the explosion stroke is calculated based on an interval between tooth waveforms of a crankshaft position sensor (CPS) signal, and
wherein the point of maximum angular acceleration of each engine cylinder during the explosion stroke corresponds to a point of maximum combustion pressure.

3. The method of claim 2, wherein the interval between tooth waveforms of the crankshaft position sensor (CPS) signal is corrected by reflecting an interval between tooth waveforms in an overrun region to exclude a mechanical tolerance.

4. The method of claim 3, wherein the point of maximum angular acceleration of each engine cylinder during the explosion stroke is calculated by calculating a factor of time variation rate using the corrected interval between tooth waveforms of the crankshaft position sensor (CPS) signal and by using a minimum point of the factor of time variation rate.

5. The method of claim 4, wherein a quadratic function is generated based on three values including the minimum point of the factor of time variation rate, a factor of time variation rate at a point prior to the minimum point by a predetermined time, and a factor of time variation rate at a point after the minimum point by the predetermined time, and a minimum value of the quadratic function is designated as a new minimum point of the factor of time variation rate in the calculation of the point of maximum angular acceleration of each engine cylinder during the explosion stroke.

6. An apparatus for detecting a combustion phase of an engine by an angular acceleration signal and combustion data of a single cylinder, the apparatus comprising:
a detector including a crankshaft position sensor (CPS) mounted on a crankshaft and a combustion pressure sensor mounted on any one of engine cylinders to detect a combustion phase of the engine cylinder;
an engine control unit (ECU) configured to determine combustion phases of all engine cylinders based on signals received from the detector; and
an injector configured to adjust an amount and a time of fuel injection on the basis of a signal transmitted from the ECU.

7. The apparatus of claim 6, wherein the ECU calculates a time difference between a point of maximum angular acceleration and the combustion phase of the engine cylinder provided with the combustion pressure sensor mounted thereon, and determines a combustion phase of an engine cylinder where the combustion pressure sensor is not mounted by using the time difference and the point of maximum angular acceleration of the engine cylinder where the combustion pressure sensor is not mounted.

8. The apparatus of claim 6, wherein the detector detects the combustion phase of the engine cylinder provided with the combustion pressure sensor mounted thereon.

9. The apparatus of claim 6, wherein the ECU calculates a point of maximum angular acceleration of each engine cylinder during an explosion stroke based on an interval between tooth waveforms of the crankshaft position sensor (CPS) signal detected by the detector,
wherein the point of maximum angular acceleration of each engine cylinder during the explosion stroke corresponds to a point of maximum combustion pressure.

10. The apparatus of claim 9, wherein the ECU corrects the interval between tooth waveforms of a crankshaft position sensor (CPS) signal by reflecting an interval between tooth waveforms in an overrun region to exclude a mechanical tolerance.

11. The apparatus of claim 10, wherein the ECU calculates a factor of time variation rate based on the corrected interval between tooth waveforms of the crankshaft position sensor (CPS) signal and calculates the point of maximum angular acceleration of the engine cylinder by using a minimum point of the factor of time variation rate.

12. The apparatus of claim 11, wherein the ECU generates a quadratic function based on three values including the minimum point of the factor of time variation rate, a factor of time variation rate at a point prior to the minimum point by a predetermined time, and a factor of time variation rate at a point after the minimum point by the predetermined time, designates a minimum value of the quadratic function as a new minimum point of the factor of time variation rate, and calculates the point of maximum angular acceleration of the engine cylinder by using the new minimum point of the factor of time variation rate.
